(19) United States
(12) Patent Application Publication
(10) Pub. No.: US 2026/0154351 A1
(43) Pub. Date: Jun. 4, 2026

(54) SYSTEMS AND METHODS FOR CONTENT ITEM MANAGEMENT AND RECOMMENDATIONS

(71) Applicant: Webidoo Inc, Chicago, IL (US)

(72) Inventor: Giovanni FARESE, San Nicola La Strada (IT)

(73) Assignee: Webidoo Inc, Chicago, IL (US)

(21) Appl. No.: 19/119,630

(22) PCT Filed: Oct. 11, 2023
(86) PCT No.: PCT/US2023/076535

§ 371 Date: Apr. 9, 2025

Related U.S. Application Data
(60) Provisional application No. 63/416,087, filed on Oct. 14, 2022.

(51) Int. Cl. G06F 16/9035; G06F 16/9032; G06F 16/906; G06N 20/00

(52) U.S. Cl. CPC G06F 16/9035; G06F 16/90332; G06F 16/906; G06N 20/00

(57) ABSTRACT

Content item management is provided. A system can store a data structure for a plurality of unique endpoints. The system can establish a session with online content item providers via respective application programming interfaces (APIs). The system can correlate the date between online content item providers with a unique identifier of a unique endpoint of the plurality of unique endpoints to generate aggregated endpoint information. The system can recommend an online content item for distribution based on the aggregated endpoint information and a classification of an entity.

### CROSS-REFERENCE TO RELATED APPLICATION

This disclosure claims priority to U.S. Provisional Patent Application No. 63/416,087 filed Oct. 14, 2022, which is incorporated herein by reference in its entirety for all purposes.

### BACKGROUND

Online content items can be distributed between various systems. The systems can store duplicate, different, or related data structures associated with endpoint users, devices, or addresses. The interoperation of the systems can provide online content items to endpoints. However, the data structures can be disparate, inaccessible, contain confidential information, or require association with known information.

### SUMMARY

Entities can distribute online content items to various endpoints (e.g., consumers, devices, or addresses). A distribution plan can include distribution via various online content item providers, which can each be associated with different outcomes (e.g., impressions, sales, or sentiment). The outcomes of various distribution plans can be characterized by actions associated with the across the various online content item providers, in person, or otherwise. Systems and methods to disclosed herein can aggregate the outcomes. Such systems and methods can predict an outcome of a distribution plan based on previous outcomes. Such predictions can be based on the prior activity of the entity, or of a related entity. For example, the systems and methods herein can classify entities and predict an outcome of a distribution plan based on outcomes of distribution plans of related entities (e.g., entities of a same or related class). The systems and methods herein can recommend a distribution plan based on a predicted outcome of the plan. For example, a distribution plan to increase sales can be recommended based on the predicted outcome of the plan, including a number, value, or type of sale. The predicted outcome can increase computational efficiency by reducing a number of online content items provided to achieve a desired outcome, which may reduce computation time, energy use, or computing resources employed to distribute the online content items or maintain distribution information associated with the online content items.

The disclosed solutions have technical advantages for computing devices. For example, the data processing system can access data via an API of an online content item provider rather than storing the data locally. Such remote storage can also permit anonymization for data, and increase storage efficiency. The storage of data structures for access by the data processing system or the online content item provider can reduce power use, relative to methods which contain duplicate materials, or which re-associate individuals based on characteristics. Further, such systems and methods permit an association of cross-platform endpoint activity, to associate a distribution plan with an outcome.

Systems and methods of the present technical solution can include a classification engine to classify an entity, a prediction engine to predict an outcome of various online content items, which can be presented via a user interface to a user to select, approve, or adjust an option. An aggregation engine can aggregate information such as data structures, or access tokens between a data repository of the data processing system and a data structure or other information, such as access tokens of an online content item provider.

At least one aspect is directed to a system. The system can include one or more processors of a data processing system coupled with memory. The data processing system can store a data structure for a plurality of unique endpoints. The data processing system can establish a session with a first online content item provider. The data processing system can access a data field from the first online content item provider via a first application programming interface (API). The data processing system can establish a session with a second online content item provider. The data processing system can access a data field from the second online content item provider via a second API. The data field from the first online content item provider can correspond to the data field from the second online content item provider. The data processing system can correlate the data field from the first online content item provider and the data field from the second online content item provider with a unique identifier of a unique endpoint of the plurality of unique endpoints to generate aggregated endpoint information. The data processing system can recommend an online content item for distribution based on the aggregated endpoint information and a classification of an entity.

At least one aspect is directed to a method. The method can be performed by a data processing system. The method can include generating a plurality of prompts for an entity. The method can include causing the plurality of prompts to be conveyed to a user interface. The method can include receiving responses corresponding to each of the plurality of prompts. The method can include classifying the entity according to the responses. The method can include storing endpoint information for a plurality of unique endpoints. The method can include establishing a session with an online content item provider. The method can include accessing a data field from the online content item provider via an API. The method can include associating the data field with a unique identifier of a unique endpoint of the plurality of unique endpoints to generate aggregated endpoint information. The method can include recommending an online content item for distribution based on the aggregated endpoint information and the classification of the entity.

At least one aspect is directed to a non-transitory computer-readable media. The computer-readable media can contain instructions to cause processors of a data processing system to perform a process. The process can include generating a plurality of prompts for an entity. The process can include causing the plurality of prompts to be conveyed to a user interface. The process can include receiving responses corresponding to each of the plurality of prompts. The process can include classifying the entity according to the responses. The process can include storing endpoint information for a plurality of unique endpoints. The process can include establishing a session with an online content item provider. The process can include accessing a data field from the online content item provider via an API. The method can include associating the data field with a unique identifier of a unique endpoint of the plurality of unique endpoints to generate aggregated endpoint information. The method can include recommending an online content item for distribution based on the aggregated endpoint information and the classification of the entity.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a data processing system, in accordance with some aspects.

FIG. 2 depicts the data processing system of FIG. 1, networked with a plurality of devices or online content item providers, in accordance with some aspects.

FIG. 3 depicts arrays of data structures, in according with some aspects.

FIG. 4 depicts a predicted outcome display from the distribution of online content items, in accordance with some aspects.

FIG. 5 depicts a display for a graphical user interface (GUI), in accordance with some aspects.

FIG. 6 depicts a display for a graphical user interface, in accordance with some aspects.

FIG. 7 depicts a flow diagram for a method according to the present disclosure, in accordance with some aspects.

FIG. 8 depicts another flow diagram for a method according to the present disclosure, in accordance with some aspects.

FIG. 9 is a block diagram illustrating an architecture for a computer system that can be employed to implement elements of the systems and methods described and illustrated herein. FIG. 10 depicts a display for a graphical user interface, in accordance with some aspects.

FIG. 11 depicts a display for a graphical user interface, in accordance with some aspects.

FIG. 12 depicts a display for a graphical user interface, in accordance with some aspects.

FIG. 13 depicts a display for a graphical user interface, in accordance with some aspects.

FIG. 14 depicts a display for a graphical user interface, in accordance with some aspects.

FIG. 15 depicts a display for a graphical user interface, in accordance with some aspects.

FIG. 16 depicts a display for a graphical user interface, in accordance with some aspects.

FIG. 17 depicts a display for a graphical user interface, in accordance with some aspects.

FIG. 18 depicts a display for a graphical user interface, in accordance with some aspects.

### DETAILED DESCRIPTION

Following below are more detailed descriptions of various concepts related to, and implementations of, methods, apparatuses, and systems of pre-charge voltage control. The various concepts introduced above and discussed in greater detail below may be implemented in any of numerous ways.

The present disclosure is directed to systems and methods of content item management and recommendation. A data processing system can classify an entity according to various user responses to prompts or according to attributes of the entity. For example, the data processing system can classify various entities according to defined attributes (e.g., revenue, location or sector). The data processing system can classify various entities into a classification such that results for each member of the class, or related classes, can be predictive for other members of the class or related classes. For example, two hair salons sharing a same location and client demographics can be classified in a same class. A outcome of a distribution of online content items (e.g., advertisements) for one hair salon can be predictive of an outcome for the other salon. A nail salon can be predictive for either hair salon. The data processing system can interface with one or more online content item providers such as search engines, email providers, or social media sites to provide online content items to endpoints. The data processing system can aggregate information between the online content item providers or other information stored by the data processing system.

The disclosed solutions have a technical advantage of more efficient storage. For example, the data processing system can access data via an API of an online content item provider rather than storing the data locally. Such remote storage can also permit anonymization for data, and increase storage efficiency. The storage of data structures for access by the data processing system or the online content item provider can reduce power use, relative to methods which contain duplicate materials, or which re-associate individuals based on characteristics. Further, such systems and methods permit an association of cross-platform endpoint activity, to associate a distribution plan with an outcome. Such a recommendation can be of increased reliability relative to other methods.

Systems and methods of the present technical solution can include a classification engine to classify an entity, a prediction engine to predict an outcome of various online content items, which can be presented via a user interface to a user to select, approve, or adjust an option. An aggregation engine can aggregate information such as data structures, or access tokens between a data repository of the data processing system and a data structure or other information, such as access tokens of an online content item provider. The systems and methods can provide a suggestion for a distribution plan, or execute a distribution plan, such as via an online content item provider.

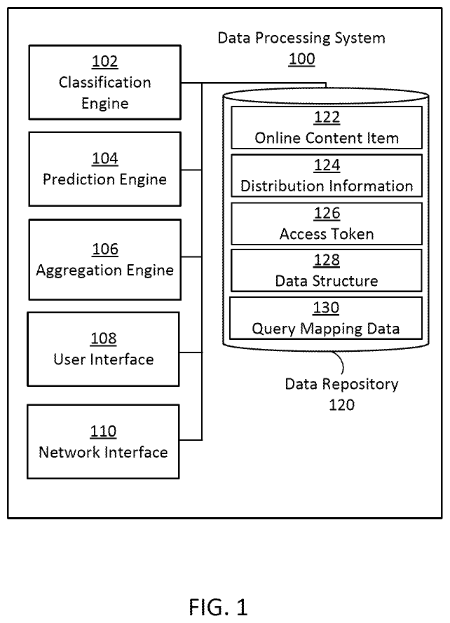

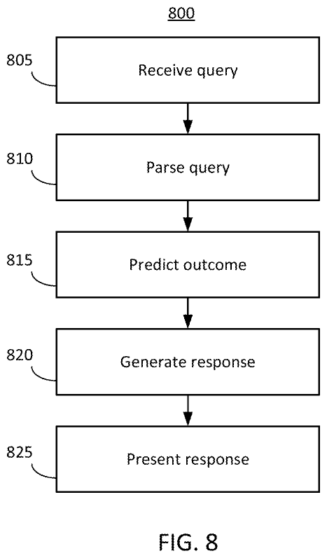

FIG. 1 depicts a data processing system 100, in accordance with some aspects. The data processing system 100 can include at least one classification engine 102, prediction engine 104, aggregation engine 106, user interface 108, network interface 110, or data repository 120. The classification engine 102, prediction engine 104, aggregation engine 106, user interface 108, or network interface 110 can each include at least one processing unit or other logic device such as programmable logic array engine, or module configured to communicate with the data repository 120 or database. The classification engine 102, prediction engine 104, aggregation engine 106, user interface 108, network interface 110, or data repository 120 can be separate components, a single component, or part of the data processing system 100. The data processing system 100 can include hardware elements, such as one or more processors, logic devices, or circuits. For example, the data processing system 100 can include one or more components or structures of functionality of computing devices depicted in FIG. 8.

The data repository 120 can include one or more local or distributed databases, and can include a database management system. The data repository 120 can include computer data storage or memory and can store one or more of online content items 122, distribution information 124, access tokens 126, data structures 128, or query mapping data 130. The online content items 122 can include items for distribution to an endpoint device. For example, the online content items can include invitations, promotional offers, or other communications such holiday greetings, status updates, branding messages, or advertisements. The online content items 122 can be textual, image or video based, audio, mixed media, or otherwise convey information.

The distribution information 124 can include a record of any previous online content item 122 provided to an endpoint, or engagement therewith. For example, the distribution information can include a history of emails sent to a consumer, and an indication of access of one or more emails, an online content item 122 provided to a consumer, and any engagement therewith (e.g., click-through, commenting, or liking). The distribution information 124 can include data which can be associated with the online content items 122. For example, a consumer sentiment or sales growth can be associated with distribution of an online content item 122. The distribution information 124 can correspond to a unique identifier of the data structure 128 or an aggregate impact. For example, distribution information can include a sales growth for a group of identified consumers provided with an advertisement, or an overall sales growth correlated with providing the advertisement. The access tokens 126 can include a credential such as a username, password or other credential, or key to access one or more resources, or to validate an identity. For example, the access token can be a symmetric or asymmetric key pair or a portion thereof.

The data structures 128 can include information related to an information endpoint such as a consumer or an associated device. For example, the data structure 128 can include information related to a mobile device (e.g., IP address, advertiser identification, cookie, phone number, location, device manufacturer, or device model). The data structure 128 can include information about a consumer associated with the mobile device. For example, a known or presumed identity (including a non-personally identifiable identity, such as an advertiser ID), an occupation, interest, demographic information, location information or language can be stored in the data structure 128. Although other information disclosed herein can be stored a variety of arrays, tables, databases, or other structures, references to “data structures” 128 as used herein refers to a data structure 128 comprising information associated with an information endpoint (e.g., a device or associated consumer). Some devices can be associated with more than one consumer (e.g., a shared computer); some consumer can be associated with more than one device (e.g., a mobile phone and a laptop computer).

The query mapping data 130 can include information relating to natural language queries. For example a model of the classification engine 102 can receive (or be trained on) query mapping data 130. The model can include, for example, a large language model configured to receive inputs or generate outputs, such as any of the information conveyed between a user and the data processing system 100, via the user interface 108. Query mapping data 130 can relate to a topic, outcome, descriptive characteristic, or other information. For example, the query mapping data 130 can include an association between various keywords, phrases, or other grams and predefined categories. The data processing system 100 can employ the query mapping data 130 to generate natural language outputs for presentation, the natural language outputs associated with predictions (e.g., of a prediction engine 104). The data processing system 100 can employ the query mapping data 130 to generate inputs configured to interface with the prediction engine 104 based on receipt of a natural language query from the user interface 108.

The data processing system 100 can include at least one classification engine 102 designed, constructed, or operational to classify an entity. The classification engine 102 can receive information indicative of a class of the entity from the user interface 108. For example, the user interface 108 can convey a response to a prompt presented to a user, or can provide information, such as a sector, size, or other attribute of an entity responsive to the entity being entered, selected, or otherwise associated with the user interface 108. The classification engine 102 can classify an entity according to various attributes. For example, the classification engine 102 can classify an entity according to a size such as a number of employers, customers, locations, advertising spend, or sales. The classification engine 102 can classify an entity according to a region such as a region being urban, rural, English speaking, Spanish speaking, or North American. The classification engine 102 can classify an entity according to a sector such as heavy industrial, retail, or fashion. The classification engine 102 can classify an entity according to a target audience, such as a demographic (e.g., income, location, or occupation).

The classification engine 102 can classify an entity according to one or more predefined classifications. For example, a predefined classification can be provided by manual entry or selection of a user, or previously determined by the classification engine 102 or another component of the data processing system 100. The predefined classifications can be mutually exclusive or cumulative. The classifications can be indicative of an attribute of the entity, or of an online content item distribution plan for the entity. The classification engine 102 can reclassify an entity according to the addition, omission, or substitution of one or more predefined classifications or based on an additional or changed attribute of the entity. For example, the classification engine 102 can reclassify the entity, upon the receipt of additional information or upon an input from the user interface 108. The additional information can include an interaction with an online content item 122. For example, a first online content item 122 can be provided to one or more endpoints associated with the entity. The classification engine 102 can classify an entity based on the distribution information 124 related to the online content item 122.

The classification engine 102 can classify an entity according to one or more dynamic classifications. For example, the classification engine 102 can plot attributes of an entity into a multidimensional space (e.g., a multidimensional matrix or hyper-plane). The multidimensional space can include attributes of an entity (e.g., goods or services provided by the entity) and a desired outcome (e.g., objective) for the entity. Clusters of entities can define classes or be classified based on proximity to related entities or clusters. Classes can be defined by supervised or unsupervised machine learning, or by another associational technique (e.g., by k-means clustering or k-nearest neighbor (KNN), or a pre-defined or dynamic threshold can define the clusters. The classification engine 102 can classify entities according to a decision tree model, a random forest model, a neural network, a support vector machine (SVM), an explainable AI model (XAI), such as an explainable boost machine (EBM), a Bayesian model (e.g., a Naive Bayes model). The models can be trained based on various entity attributes or outcomes associated therewith. The clusters can thereafter be grouped to form classes. The classifications can be adjusted in response to distribution information 124. For example, if a distribution of an online content item 122 by email results in engagement above or below a threshold, the entity can be re-classified.

The classification engine 102 can determine one or more desired outcomes for a distribution plan. For example, for one or more classes of entity, (e.g., including luxury goods retailers), an outcome of brand perception can be prioritized relative to an immediate sales outcome. The desired outcomes can be based on direct input from the user (e.g., a ranked or weighted objective), or can be determined according to a class. For example, the desired outcomes can be based on an age, size, or customer demographic of an entity. The classification engine 102 can update the desired outcomes based on a user entry, entity classification, or detected outcome trend. The classification model can detect the trends based on the desired outcomes of a same or related class entities. The update can be responsive to a user notification conveying the detected trend to a user, or can be automatically adjusted.

The classification engine 102 can classify an entity according to topic information received from a user interface 108. The classification engine 102 can a classify an entity according to a natural language input associated with a target, goal, or other information associated with the entity. For example, the classification engine 102 can receive an indication that an entity is a services entity, and is interested in distributing content items to increase sales, engagement, and brand awareness within a particular geography, demography, or the like. The classification engine 102 can receive the indication as a predefined selection, or as a natural language query (e.g., the classification engine 102 can associate the natural language query with the entity based on the query mapping data 130).

The classification engine 102 can provide, to a prediction engine 104, prediction inputs based on a classification of an entity or input associated therewith (e.g., an input received from a user interface 108, such as a predefined selection or a natural language input). For example, the classification engine 102 can provide one or more inputs according to a predefined input (e.g., relating to search engine optimization (SEO), pay per click (PPC) content distribution, social media site content distribution, content distribution analytics, other content distribution, or so forth). The classification engine 102 can receive a response from the prediction engine 104. Based on the response, the classification engine 102 can cause an output of information. For example, the output can be an adjustment to a presentation of a user interface 108 (e.g., a predefined portion of a graph or chart, or a presentation of a natural language string). For example, the classification engine 102 can receive, from the prediction engine 104, various predictions associated with a query. The various inputs and outputs described herein can refer to same or different outputs. For example, implementations can include at least a portion of any of the classification engine 102, the prediction engine 104, or the user interface 108 to be separated by predefined interfaces (e.g., APIs), or to include a same large language model (LLM) such that exchanges of information between the various components of the data processing system 100 can occur within the LLM.

The data processing system 100 can include at least one prediction engine 104 designed, constructed, or operational to predict an outcome associated with an online content item 122 distribution plan. The prediction engine 104 can predict an outcome for a class or an individual entity. The prediction engine 104 can predict an outcome based on one or more related online content item 122 distribution plans. For example, an online content item 122 distribution plan can be matched with one or more reference online content item 122 distribution plans of the entity or another entity. The reference online content item 122 distribution plans can be assigned a weight according to a similarity of the entity or the distribution plans (e.g., size, target, time of year, time of day, or the like). For example, an identical distribution plan of the same entity can be assigned a weight of 1, a related distribution plan of the same entity can be assigned a weight of 0.8, a similar distribution plan of another entity having a same class can be assigned a weight of 0.6, and a similar distribution plan of another entity of a related class can be assigned a weight of 0.5.

The prediction engine 104 can include a machine learning model. The machine learning model can be trained according to a set of training data. The training data can include previous distribution plans of the entity or of related entities. The training data can include distribution information 124 associated with the previous distribution plans. The machine learning model can be an explainable AI model, wherein past distribution information 124 is correlated with various distribution plans such that a portion of a distribution plan can be correlated with an outcome.

Distribution plans can include, for example, an email campaign to former purchasers, a targeted advertising campaign to consumers similar to a target demographic, or a blog post published on an entity website or an online content item provider website.

The machine learning model can include a natural language processing (NLP) model. The NLP model can compare texts related with of one or more distribution plans. For example, a distribution model can include an online content item provider such as a social media platform, a blog, website, or email communication. The language model can include language from the entity, other entities of a same or related class, or can be intrinsic to the model. For example, the prediction engine 104 can generate, receive, store, or process a natural language description of one or more online content item providers for the distribution plan. The NLP model can determine an online content item provider based on a desired outcome, an entity attribute, or a class attribute.

The NLP model can match language according to one more gram sizes such as bi-grams, tri-grams and so on, or can compare based on atomic words or characters. The NLP model can rank the occurrence of the (e.g., bi-grams) based on the recurrence or position thereof. For example, a linear model, term frequency-inverse document frequency model, or a variant thereof can be applied.

The NLP model can compare the description of the online content item provider to a set of online content item providers. The description for the online content item providers or the desired outcome can include a contraindication portion, which the prediction model can compare. For example, a seatbelt awareness campaign can include a contraindication for commuter cyclists, and a cycling enthusiast social media property can include a contraindication for motorists. The prediction engine 104 can include a weighting based on other online content item providers employed by the entity. For example, the prediction engine 104 can increase or decrease a weight of an online content item provider based on a similarity or dissimilarity of another online content item provider employed by the entity, or related entities. The prediction engine 104 can employ various supervised or unsupervised models to determine similarity, such as k-means or KNN. A distance (e.g., similarity) can be determined by a cosine distance, Euclidean distance, or Manhattan distance. The NLP model can be a same or different instance or type of model employed by the user interface (e.g., as a conversational AI). For example, the NLP model can determine a similarity to a topic to determine a topic of a query according to a technique employed to determine a similarity between entities.

The prediction engine 104 can determine one or more outcomes of an online content item 122 distribution plan or other action. For example, the prediction engine 104 can predict an expense of a distribution plan, a change in engagement resulting from a distribution plan, a sales change as a result of a distribution plan, a number of unique visitors, a brand or other perception (e.g., positive, negative, aspirational), or an awareness of a brand or other information. Various predictions can be relevant to a particular distribution plan. For example, a distribution plan to encourage safe driving may not be associated with a sales change, but may be associated with other information presented to the information processing system (e.g., average speed, collisions per month, or the like).

The data processing system 100 can include at least one aggregation engine 106 designed, constructed, or operational to aggregate a plurality of data structures 128 or identifiers associated with one or more online content item providers. The online content item providers can include email services, social media sites, search engines, or other online properties. Some online content item providers can provide a same view to one or more consumers (e.g., a public location). For example, a blog post can be viewed identically by various consumers. Some online content item providers can provide a different view to one or more consumers. For example, a social media site can provide online content items 122 such as paid advertisements, photographs, or video clips which an entity can publish via a nonpublic location, such as a display generated for a particular endpoint. Each online content item provider can include one or more user-accessible views. Each online content item provider can include one or more application programming interfaces (APIs). The API can include a predefined number of commands to interface between two or more systems. The aggregation engine 106 can establish a session with one or more online content item providers. For example, aggregation engine 106 can establish a session by the provision or validation of an access token 126, or a proof of a possession thereof (e.g., by signing a one time key with the token, generating a hash, or so forth). The aggregation engine 106 can receive a user credential for an online content item provider via the user interface 108. For example, the user credential can include login credentials, or a further token can be generated by linking the data processing system 100 to the online content item provider.

Upon establishing the session, the aggregation engine 106 can access data fields of the online content item provider. The data field can be a field of a data structure 128. The aggregation engine 106 can aggregate the data field with a data structure 128 stored by the data processing system 100, or another online content item provider. For example, the aggregation engine 106 can store a data structure 128 comprising information for an endpoint. The data structure 128 can include one or more data fields which can uniquely identify an endpoint. For example, a phone number, an email field, or a combination of a location, birth date, first name, and last name can uniquely identify an endpoint.

Each online content item provider can include one or more data fields to uniquely identifiers consumer, which can be anonymized (e.g., a table row number). The various data fields can include one or more formats for content thereof. For example, an online content item provider or the aggregation engine 106 can store a name according to a free text field. Another online content item provider or the aggregation engine 106 can include separate data fields for a first and last name. The aggregation engine 106 can aggregate the information to determine engagements with one or more endpoints. For example, distribution information 124 can include an email sent to an email address. A device or consumer associated with the email address can thereafter visit the social media page of associated with the email. Thus, the aggregation engine 106 can determine consumer engagement responsive to the email campaign, by aggregating information of identifiable endpoints.

The aggregation engine 106 can aggregate endpoints for distribution of online content items 122. For example, the aggregation engine 106 can provide one or more endpoints to an online content item provider vie the API. The aggregation engine 106 can request additional endpoints based on the provided endpoints. For example, the aggregation engine 106 can receive one or more data structures 128 from the online content item provider responsive to the request, or the aggregation engine 106 can provide an online content item 122 for the online content item provider to convey to additional endpoints (e.g., the aggregation engine 106 may not receive data structures 128 associated with the respective endpoints). The aggregation engine 106 can receive one or more indications of consumer engagement associated with the online content item 122 such as impressions, comments, views, or sales.

The data processing system 100 can include at least one user interface 108 designed, constructed, or operational to convey information between a data processing system 100 and a user. The user interface 108 can present one or more questions to a user. The user interface 108 can include a graphical user interface (GUI) on a touchscreen or other display. The user interface 108 can include a user entry device such as a touchscreen, keyboard, API, or a web interface such as an email server or file transfer protocol server to convey the information between the user and the data processing system 100. The user interface 108 can present one or more prompts to the user for input. For example, the user interface 108 can present questions to the user to classify an entity. The user interface 108 can present a predefined set of questions, questions can be based on responses to previous user responses to questions, or questions can be generated according to an LLM to iteratively prompt an entry of actionable information. For example, a first question can identify a sector of an entity, whereupon the user interface 108 can provide a list of potential sub-sectors for selection by the user.

The user interface 108 can receive queries according to predefined or dynamic entries of the query. For example, a user can select a button, drop down, or other feature of the user interface 108, or provide a natural language query. A natural language query can include, for example, a free-form text query or a verbal query. The natural language query can relate to management or recommendation of content items (e.g., to digital marketing). The user interface 108 can parse the natural language query to determine topic information thereof, or provide the natural language query to the classification engine 102 for topic classification. The user interface 108 can parse the natural language query for one or more keywords or other grams. For example, the other grams can correspond to phases or entities, such n-gram matching including fuzzy matching, n-gram term frequency-inverse document frequency, relative to other information associated with various topics, etc. The keywords can be predefined or determined based on frequency, association with a topic, or so forth. For example, the topic information can relate to a selection of search engine optimization (SEO), pay per click (PPC) content distribution, social media site or other online content item provider, content distribution analytics, other content distribution, or so forth. The user interface 108 can provide the natural language query, or the topic information to the classification engine 102 or prediction engine 104 for response classification, prediction, or generation or responses.

The user interface 108 can present one or more potential outcomes of a distribution plan. The distribution plan can be associated with one or more outcomes or inputs. For example, the user interface 108 can present a predicted outcome of one or more distribution plans as determined by the prediction engine 104. The user interface 108 can receive an outcome of sales growth, revenue per consumer, average selling price, or brand perception from the prediction engine 104 for presentment. The user can provide a weight, rank order, or other priority of the outcomes. The user can provide a spend amount or range. The user interface 108 can present one or more distribution plans, responsive to the user input. The user interface 108 can provide a predicted value for one or more outcomes, as predicted by the prediction engine. For example, the user interface 108 can suggest posting an online content item 122 to a publicly facing page (e.g., a website or profile), or providing an online content item 122 via one or more online content item providers, such as an email service or social media site.

The user interface 108 can present one or more distribution plans, online content items 122, or data structures 128. A recommended distribution plan presented by the user interface 108 can include an email to previous endpoints which have not used a service for at least three months, and a targeted advertisements to consumers meeting age or location criteria. The user interface 108 can present an option for the user to approve the plan or modify a parameter thereof. For example, the user can increase or decrease a budget, or demographic for targeted endpoints. The user interface 108 can present a number of endpoints for a distribution plan. For example, a distribution plan can reach ten, ten thousand, or ten million consumers. Upon an adjustment to the distribution plan received by the user interface 108, the user interface 108 can update the number of endpoints. The user interface 108 can receive the number of endpoints from an online content item provider, such as from the API associated therewith.

The user interface 108 can include a large language model (LLM) configured to exchange (e.g., send or receive) information from a user or other components of the data processing system 100. For example, the LLM can generate or receive natural language response including any of the information presented or received by the user interface 108.

The user interface 108 can include or interface with a calendar. For example, a calendar view can depict a schedule of jobs and any availability. The calendar can be or interface with a calendar of an online data item provider. For example, the online data item provider can present a calendar of availability to an endpoint, or can receive a request for an appointment, whereupon the user interface 108 can receive the request (e.g., via a push or pull operation). The user interface 108 can automatically, or upon a confirmation of a user, confirm the appointment, or assign the appointment within an entity (e.g., to an employee or contractor associated with the entity).

The data processing system 100 can include at least one network interface 110 designed, constructed, or operational to convey information between the data processing system 100 and one or more online content item providers or endpoints. The network interface 110 can convey messages to or from various public or private networks. For example, the network interface 110 can include, interface with, or be associated with one or more network edges which can include firewalls, forwarding, or filtering. For example, the network interface 110 can convey information between one or more of the components of the data processing system 100 on a private network (e.g., an Ethernet, PCIe, or other private network). The network interface 110 can convey information or selectively route traffic between the private network and a public network (e.g., a cellular network or the Internet.)

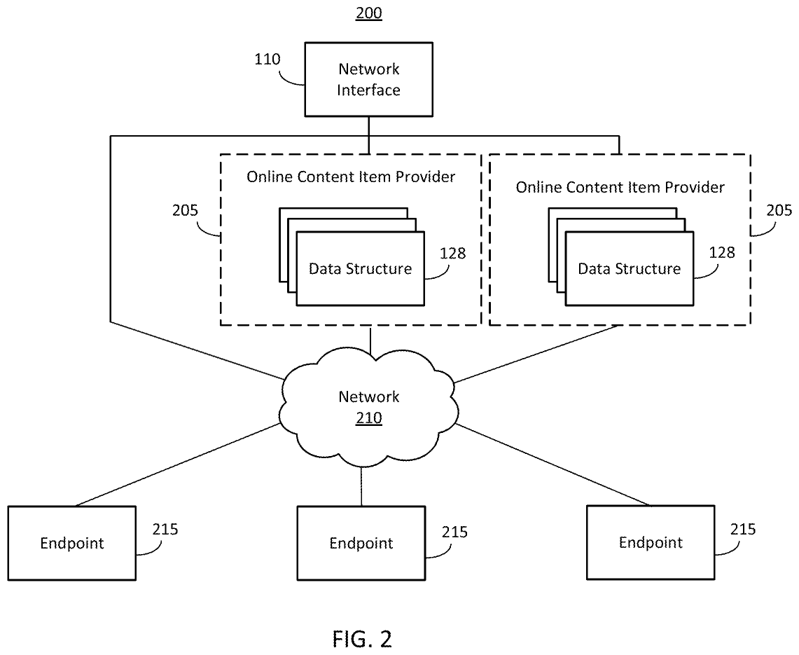

FIG. 2 depicts the data processing system 100 of FIG. 1 networked with various devices or online content item providers 205, in accordance with some aspects. The network interface 110 of the data processing system 100 can establish a connection with one or more online content item providers 205. The data processing system 100 (e.g., an aggregation engine 106 thereof) can communicate with the online content item providers 205 or endpoints 215 via a network 210, such as the Internet. The network 210 can include a public network 210 and one or more private network 210 connections. For example, the network 210 can include sessions established between the data processing system 100 and one or more endpoints 215 or online content item providers 205.

The online content item providers 205 can include third party online content item providers 205 such as social media properties, or advertisers. The online content item providers 205 can include second party online content item providers 205 such as an email service to convey content provided by the network interface 110. The online content item providers 205 can include first party online content item providers 205. For example, the online content item providers can include a first party blog or website of an entity. The various online content item providers 205 or the data processing system 100 can communicate with one or more endpoints 215 to cause a desired outcome generated by the prediction engine 104. For example, the data processing system 100 can send, or cause to be sent, an SMS to a set of endpoints 215 based on a data structure 128 of the data processing system 100 or of one or more of the online content item providers 205. The data processing system 100 can send, or cause to be sent, an email to a set of endpoints 215 based on a data structure 128 of the data processing system 100 or of one or more of the online content item providers 205. The data processing system 100 can send, or cause to be sent, an online content item to a set of endpoints 215 based on a data structure 128 of the data processing system 100 or of one or more of the online content item providers 205.

The data processing system 100 can receive distribution information 124 such as click-through data, sales data, or other information. The distribution information 124 can be associated with one or more unique endpoints 215. The distribution information 124 can be aggregated or anonymized such that no particular endpoint 215 is identified, wherein endpoint behavior is associated with one or more online content items 122. For example, the data processing system 100 can receive an indication that a purchase or view is associated with an emailed online content item 122. The various sets of endpoints 215 can be a same set or different set, such as an exclusive set or a wholly or partially overlapping set. Each online content item provider 205 can include one or more data structures 128 associated with one or more endpoints 215. The endpoints 215 can include devices or end-users. For example, the endpoints 215 can be or be associated with a consumer of an online content item provider 205 such as a social media network or email service.

The network interface 110 can convey, via the network 210, information between the endpoints 215, the online content item providers 205, or the aggregation engine 106. For example, the network interface 110 can convey identifiable or anonymized data structures 128. The data structures 128 can be aggregated based on a predefined set of data fields.

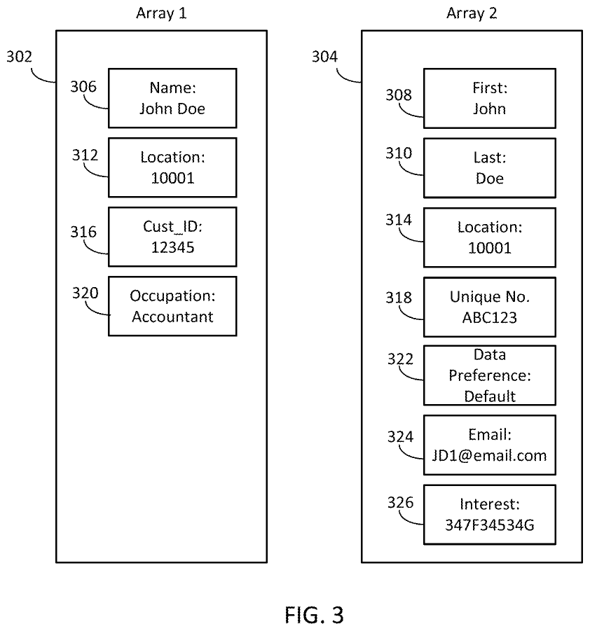

FIG. 3 depicts data arrays of data structures 128, in accordance with some aspects. Each array can be defined according to a data structure 128 of an online content item provider 205 or the data repository 120. For example, the first array 302 can be from an online content item provider 205 and the second array 304 can be from a different online content item provider 205. Although not depicted, further arrays can be associated with one or more data structures 128 of the online content item providers or the data repository 120. For example, an array for non-identifiable information, or an array for use in (or transfer between) a defined geographic region, or according to a consumer preference can be defined for each data structure 128. For example, the data processing system 100 can collect information from an endpoint 215. A consumer associated with the endpoint 215 can agree to certain information being collected and distributed for limited purposes, but object to its distribution for other purposes. An array can be generated for the limited purposes, and a different array can be generated for other purposes.

Each array can contain one or more data fields; the aggregation engine 106 can define relationships therebetween. For example, the first array 302 includes a “name” data field 306, which contains information corresponding to a “first” data field 308 and a “last” data field 310 of the second array 304. The aggregation engine 106 can include one or more rules to aggregate the information of the various data structures 128. Such rules can lower power use, relative to other techniques. For example, the rule can specify that the “name” data field 306 of the first array 302 be cast to two data fields delimited by a space character. If no match is found, the aggregation engine 106 can employ a fuzzy matching scheme (e.g., using the n-gram similarity methods of the prediction engine 104). Such an approach can reduce a latency, energy use, or increase a confidence level of a match relative to other methods.

Same or related information can be stored in a data field for differently formatted data. For example, the first array 302 includes a “location” field 312 including a zip code; the second array 304 also includes a “location” data field 314 including a zip code. One value can be stored as a string of text, and the other value can be stored as an integer value. Thus, the data processing system 100 can cast between types, or store the data according to a format to reduce memory space. Further online content item 122 providers or data repositories can store information in further formats such as a city, or other geographic region. Association information can be stored by the data repository 120 of the data processing system 100. For example, the first array 302 and second array 304 can each include a unique identifier 316, 318 for an endpoint 215. The data processing system 100 can store such identifiers to reduce a time or energy use to aggregate the respective data structures 128.

Arrays can include sharing preferences. The data processing system 100 can read a data preference field 322 before accessing other information. For example, the data preference field 322 can be indicative that a certain field should not be accessed, should be anonymized prior to distribution, or the like. For example, the data preference field 322 can indicate that a query of a data field can result in an error. Some data or data preferences can vary between online content item providers. For example, the first array 302 includes an occupation field 320, whereas the second array 304 includes an email field 324 and an interest field 326. The interest field 326 can be indicative of an encoded set of preferences, or can include anonymized data. For example, the interest field can indicate a similarity to another endpoint 215.

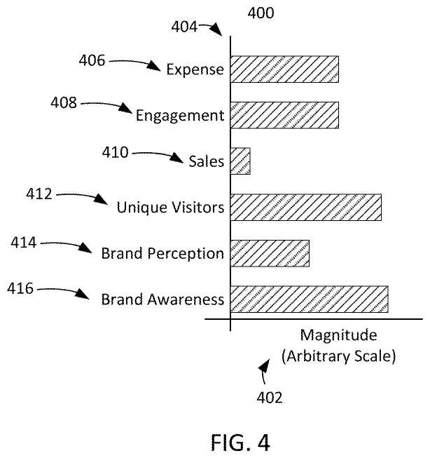

FIG. 4 depicts a predicted outcome display 400 from the distribution of online content items 122, in accordance with some aspects. The data processing system 100 can present the outcomes to a user (e.g., via a GUI of the user interface 108). The user interface 108 can select or place one or more outcomes for increased prominence according to a desired outcome. For example, the user interface 108 can receive an indication of a desired outcome, and thereafter present the indicated outcome with a first prominence. The user interface 108 can present an outcome predicted by the prediction engine 104 with a second prominence. The user interface 108 can present further outcomes with a third prominence. For example, the user interface 108 can increase a prominence of a display based on a position on the GUI (e.g., at a top), a size or text emphasis (e.g., bold or italicized text, or text of a contrasting color to the GUI), or based on a menu. For example, more prominent outcomes can be depicted on a first menu, and a user can select a submenu or scroll to access less prominent outcomes.

An axis (e.g., the x-axis 402) can depict a magnitude of a predicted outcome. The magnitude scale can vary according to the metric (e.g., dollars, views, or response rate). The various metrics can be normalized for viewing on the graphical user interface 108. For example, normalization can include a scaling between entities or scaling between metrics of an entity. An axis (e.g., the y-axis 404) can include one or more outcome metrics. Although depicted as positive magnitudes, some outcomes can include negative outcomes for one or more metrics. The various outcome metrics can be particular to an identified endpoint 215 or be aggregated. An expense 406 can include direct or indirect costs associated with a distribution plan. For example, expense can include advertisement spend or discounts associated with an online content item (e.g., a coupon code). Engagement 408 can include a number or type of consumer engagements such as views, comments, or other interactions with an online content item. For example, a comment or other interaction of a social media site can be received, by the network interface 110, from an online content item provider 205. Sales 410 can indicate total sales numbers, values or other attributes such as average transaction amount. Unique visitors 412 can include a number of impressions for an online content item 122, a number of visits to a website, or otherwise indicate a number of endpoints 215 reached by a distribution plan. The user interface 108 can display one or more predicted brand metrics such as brand perception 414 or brand awareness 416. For example, the user interface 108 can receive a prediction of an outcome from the prediction engine 104 for components of a distribution plan.

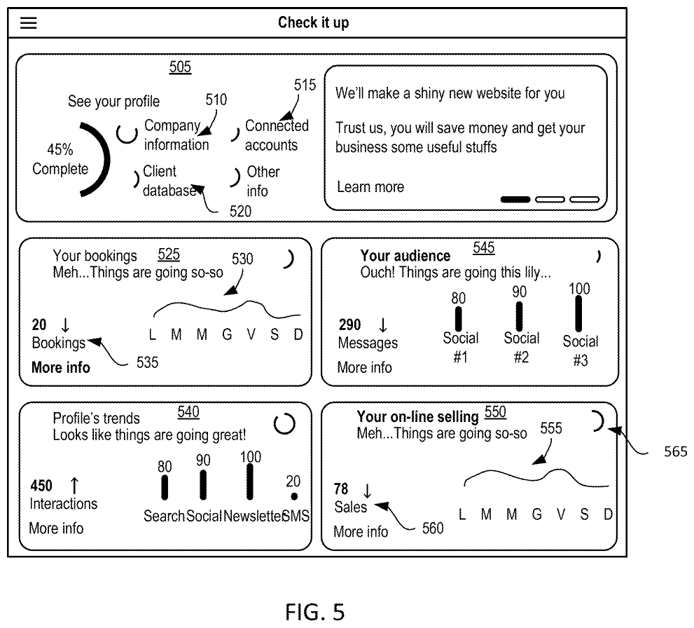

FIG. 5 depicts a display for a GUI of the user interface 108, in accordance with some aspects. The GUI can include a variety of menus, submenus and the like. The menus can be contextually sensitive. For examine, a menu can prompt a user to provide responses to prompts for the classification engine 102 or to link one or more online content item providers, and thereafter display a welcome screen containing information based on the entity classification or the linked online content item providers 205. The welcome screen can include a profile summary 505 to indicate of a completeness of a profile, such as relative to a predefined threshold or peer entities.

The profile summary 505 can depict entity information 510, connected accounts (such as online content item provider accounts) 515, or data repository 120 information such as data structures 128 stored therein (e.g., a database completeness 520).

Various summary sections can report information related to one or more aspects of the data processing system 100. The various summary sections can be omitted, substituted, or added according to a preference or class of an entity. For example, an entity can include a scheduling function such as for a personal service (e.g., a yard service or a hair stylist), and can include a scheduling summary 525. The scheduling summary 525 can include an indication of a total number of total bookings 535, repeat bookings, new client bookings, or bookings affiliated with a distribution plan. The scheduling summary 525 can include a summary of bookings over time 530, or a summary of the time, day, or month for the booking.

An one or more sections can track endpoint engagement. An engagement section can depict one or more endpoint 215 engagements. The engagements can include entity interactions 540 or endpoint interactions 545, such as such as public interactions including reviews, comments, or responses, and private interactions including emails or private comments. The data processing system 100 can associated the engagements with metrics to determine a sentiment of the engagements. The user interface 108 can include a sales section 550. The user interface 108 can present a number of sales by time 555 (e.g., time of day, day of week, or season of year), absolute number of sales 560, value of vales, or other sales metrics. One or more sections of the user interface 108 can include an indicator of overall status 565 (e.g., relative to a system predicted or user defined threshold). The prediction engine 104 can determine the threshold based on a class of the entity or a desired outcome.

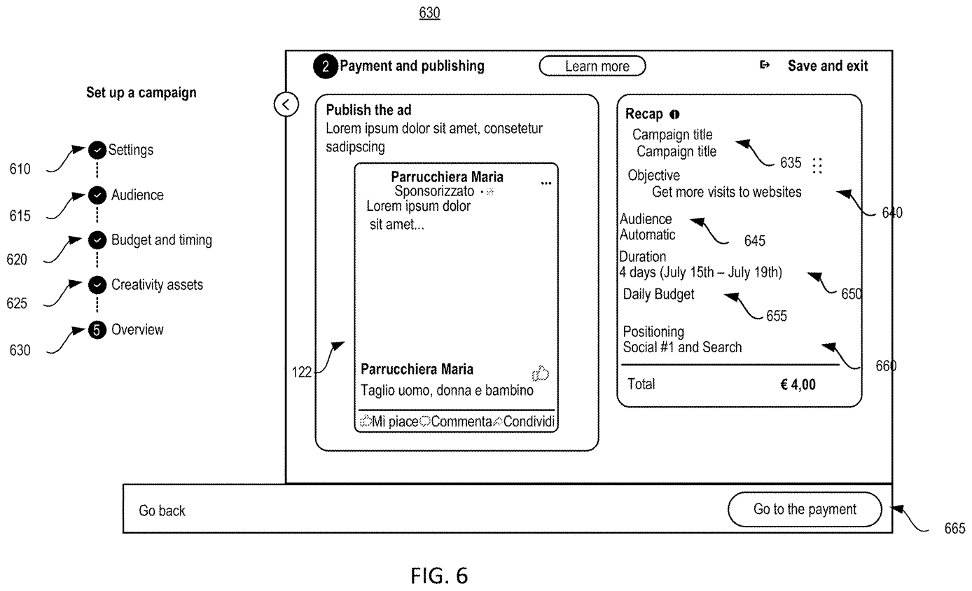

FIG. 6 depicts a display for a GUI of the user interface 108, in accordance with some aspects. The GUI can present a proposed distribution plan. The distribution plan can include various submenus. For example, a first submenu 610 can present an option to link one or more online content item providers 205 to the distribution plan. The user interface 108 can present an option to link multiple online content item providers 205 such that an endpoint action (e.g., sales, appointments, or engagement) on one online content item provider 205 can be associated with an distribution plan including another online content item provider 205. A second submenu 615 can include an audience for the distribution plan. For example, the audience can be pre-defined, or one or more options can be presented to a user (e.g., to adjust demographic information, location, interests, or other data structure 128 parameters).

A third submenu 620 can include a timing or magnitude of the distribution plan. The user interface 108 can present a proposed timing or magnitude (e.g., ad spend), responsive to a recommendation of the prediction engine 104 or based on the classification engine 102. A fourth submenu 625 can provide one or more suggested online content items 122 or prompt the user to provide an online content item 122. A fifth submenu 630 can provide a summary of the distribution plan. For example, the user interface 108 can generate or present a reference identifier 635 for the distribution plan. The user interface 108 can present a system generated or user generated desired outcome (e.g., objective 640). The user interface 108 can present a system generated or user generated distribution plan summary 645. For example, the user interface 108 can present an indication that the audience for the distribution plan is generated by the data processing system 100. The user interface 108 can present a further summary of a distribution plan, such as a duration, timing 650, or magnitude 655. The user interface 108 can present a summary of selected online content item providers 660 or other distribution methods (e.g., short message service (SMS) or telephonic communication).

The user interface 108 can include an action generator 665 to execute the distribution plan. Upon a selection of the action generator 665, the user interface 108 can cause an online content item 122 to be conveyed to one or more endpoints 215 (e.g., via communication with one or more online content item providers). The various menus or action generators 665 can be accessible via natural language, such that an entry can cause access information with one or more menus. The user interface 108 can include a confirmation element to present a standardized indication responsive to a query, to confirm an instruction determined by an NLP model.

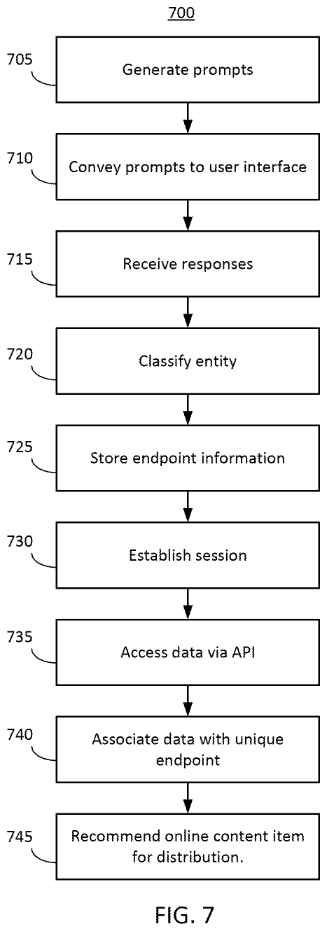

FIG. 7 depicts a flow diagram for a method 700 according to the present disclosure, in accordance with some aspects. At ACT 705, the data processing system 100 can generate prompts to classify an entity. At ACT 710, the data processing system 100 can convey the prompts to a user interface 108. At ACT 715, the data processing system 100 can receive responses to the prompts to classify the entity. At ACT 720, a classification engine 102 of the data processing system 100 can classify the entity according to the received responses. At ACT 725, the data processing system 100 can store endpoint information. At ACT 730, the data processing system 100 can establish a session with an online content item provider 205. At ACT 735, the data processing system 100 can access data from the online content item providers 205. At ACT 740, the data processing system 100 can associate data with a unique endpoint 215. At ACT 745, the data processing system 100 can recommend an online content item for distribution.

Referring again to ACT 705, a data processing system 100 can generate prompts for an entity. The prompts can be predefined, such as in whole or according to a decision tree. For example, the classification engine 102 can generate the prompts by selecting a prompt from a set of predefined prompts. The classification engine can select or otherwise generate a prompt based on a previous response. For example, classification engine 102 can generate prompts in response to a response received from another prompt at ACT 715. The prompts can be conveyed to a user interface 108 at ACT 710. For example, the prompts can be conveyed via a GUI of the user interface 108. The GUI can provide a free form or predefined list of options to a user. For example, the GUI can present a text field or a selection of one or more options.

Referring again to ACT 715, the data processing system 100 can receive the responses corresponding to each of the prompts. The user can select one or more of the options, such as via the GUI. The user interface 108 can accept a response via a keyboard, touch screen display, SMS, or another communication method. The user interface 108 can cause the responses to be normalized, such as to normalize an address, location, or industry to match a predefined format or data set (e.g., by matching the data to the predefined format or data set or conveying the data, via a network 210, for normalization). For example, the response can be normalized by a conversational AI model to map received information to one or more predefined data fields. At ACT 720, the data processing system 100 can classify an entity according to the responses. For example, the data processing system 100 can compare the entity to additional entities to classify the entity whereupon the data processing system 100 can base one or more recommendations, comparisons, or analysis based on the class.

Referring again to ACT 725, the data processing system 100 can store endpoint information (e.g., a data structure 128) for one or more unique endpoints 215. For example, the endpoint information can relate to a consumer, an address, or a device (e.g., a device for one or more consumers). The endpoint information can be stored in a data repository 120 of the data processing system 100. The endpoint information can be stored according to a data field format associated with the data processing system 100 or with one or more online content item providers. The data processing system 100 can include a conversion matrix to transpose information between various formats (e.g., formats of various online content item providers 205).

Referring again to ACT 730, the data processing system 100 can establish a session with one or more online content item providers 205. The interface can be via a network 210 or another communication channel, such as a private connection thereto. The session can be established by an exchange of one or more tokens. The token can include a credential such as a username or password or another key. The token can be a symmetric or asymmetric key which can be exchanged. The token can be a message signed by (e.g., encrypted by) the key to authenticate possession thereof. The session can be established incident to one or more transactions. For example, each transfer of data can be established as an individual session, or a session can be maintained for a transfer of data of various entities, or at various times.

Referring again to ACT 735, the data processing system 100 can access a data structure 128 for an endpoint 215 via an API from the online content item provider 205. The data structure 128 can be provided to the online content item provider 205. For example, a the data processing system 100 can access information for a same endpoint 215 as a data structure 128 of the data processing system 100, or further endpoints 215 based on a desired distribution plan. The data processing system 100 can access data structures 128 for endpoints 215 similar to a set of endpoints 215 stored by the data processing system 100. At ACT 740, the aggregation engine 106 can aggregate a data field of an online content item provider 205. For example, the aggregation engine 106 can match a data field of a data structure 128 with a corresponding data field of another online content item provider 205, or the data repository 120.

Referring again to ACT 745, the data processing system 100 can recommend an online content item for distribution based on the aggregated endpoint information and the classification of the entity. For example, the data processing system 100 can generate an online content item 122 or select an online content item 122 from a set of online content items 122 for recommendation. The recommendation can be for a user-selected online content item 122. For example, the data processing system 100 can recommend a timing or magnitude of a distribution plan for the online content item 122, or can recommend an audience or desired outcome for the online content item 122. Such a recommendation can be based on entity classification. For example, a dog groomer, ice cream parlor, and heavy industrial entity can receive different recommendations based on their respective classifications. The recommendations can be based on a matrix (e.g., a look up table) or a determination of the prediction engine 104. For example, the recommendation can be based on an outcome for another entity of a same class or a related class.

FIG. 8 depicts another flow diagram for a method 800 according to the present disclosure, in accordance with some aspects. At ACT 805, a data processing system 100 can receive a query associated with a distribution of an online content item. For example, the query can relate to a selection of the online content item, a conveyance of the online content item (e.g., according to one or more online content item providers or endpoint demographics), or an outcome associated with the selection or distribution of the online content item. The query can be entered in a user interface 108. The query can include classification information. For example, the query can be received in a menu associated with a particular topic (e.g., SEO), or the content of the query can indicate an association with the topic (e.g., “How do I improve search rankings for my new business”).

At ACT 810, the data processing system 100 can parse, via natural language processing, the query to determine one or more topics associated therewith. For example, the topics can be a predefined set of topics, or the parsing can be performed by an LLM configured to interface with distribution information 124 employed at ACT 815. The parsing can further include entity information, a desired outcome, or any other information associated with the user interface 108 (e.g., information presented by or received in a natural language query).

At ACT 815, the data processing system 100 predicts an outcome for the distribution of an online content item associated with the topic of ACT 810. For example, the prediction can be based on distribution information 124. The prediction can be performed by a machine learning model trained on online content item distribution (e.g., the distribution information 124 of the data repository or further distribution information 124). Some predictions can include multiple instances and comparisons therebetween, or comparisons to a threshold. For example, a query associated with a topic of selection of an online content item providers for content distribution can predict an outcome of multiple such providers, to respond with a provider associated with an outcome associated with the query, or can compare an outcome to a threshold (e.g., a threshold associated with an outcome).

At ACT 820, the data processing system 100 generates a response to the query. For example, the response can include a natural language response indicating the prediction. The generation can be formatted for display via the user interface 108. For example, the user interface 108 can include one or more predefined fields (e.g., return on advertising spend) which includes information presented according to a predefined format other than natural language, and a natural language portion. The generation can include depicting a natural language portion based on the user interface 108. For example, a first portion of the response can be presented via a predefined field, and a second portion of the response can be presented as natural language, or the response can be presented as a natural language string (e.g., based on a lack of association with further data elements of a user interface 108, or a user interface 108 lacking such data elements). At ACT 825, the data processing system 100 presents the response, such as by generating control signals to cause a presentation thereof.

The operations provided herein, like other examples of the present disclosure, are provided as an illustrative example as are not intended to limit the present disclosure. Additional, fewer or different ACTs can be included in instances of the method 800. For example, a data processing system 100 (e.g., an LLM thereof) can generate prompts for additional query information to determine, in combination with the query, the prediction of the outcome, the generation of the response, or the presentation of the response (e.g., the data processing system 100 can generate iterative natural language prompts).

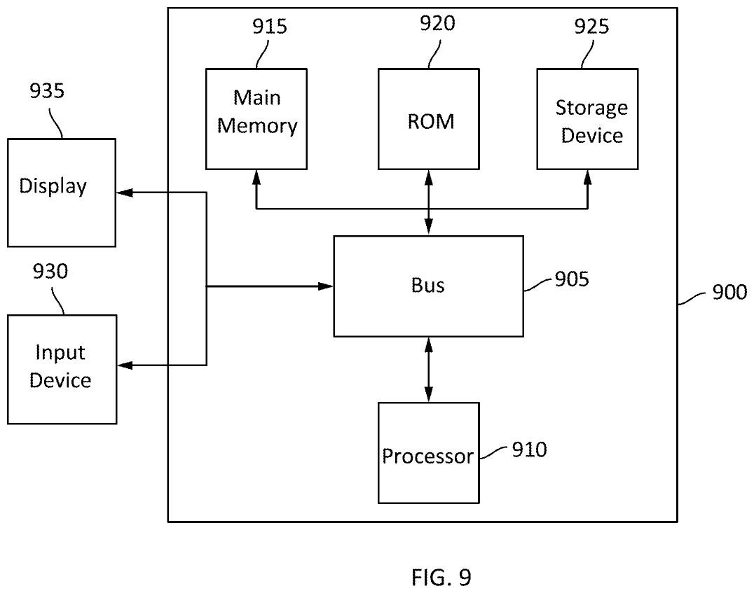

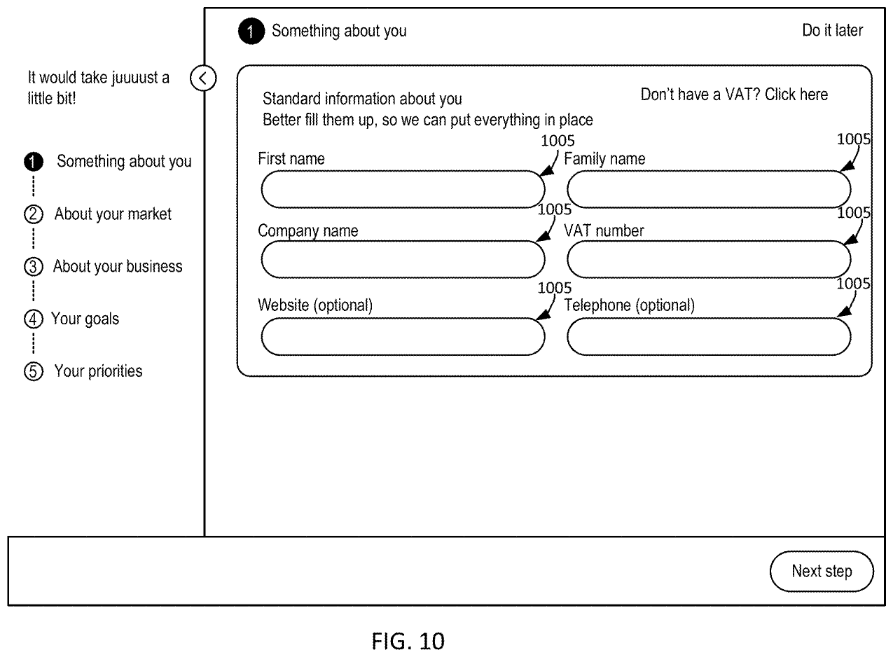

FIG. 9 is a block diagram illustrating an architecture for a computer system 900 that can be employed to implement elements of the systems and methods described and illustrated herein. The computer system or computing device 900 can include or be used to implement a data processing system 100 or its components, such as the classification engine 102, prediction engine 104, or aggregation engine 106, and components thereof. The computing system 900 includes at least one bus 905 or other communication component for communicating information (e.g., within the data processing system 100 or between the data processing system 100 and the various endpoints 215 or online content item providers 205) and at least one processor 910 or processing circuit coupled to the bus 905 for processing information. The computing system 900 can also include one or more processors 910 or processing circuits coupled to the bus for processing information. The computing system 900 also includes at least one main memory 915, such as a random access memory (RAM) or other dynamic storage device, coupled to the bus 905 for storing information, and instructions to be executed by the processor 910. The main memory 915 can be used for storing information during execution of instructions by the processor 910. The computing system 900 may further include at least one read only memory (ROM) 920 or other static storage device coupled to the bus 905 for storing static information and instructions for the processor 910. A storage device 925, such as a solid state device, magnetic disk or optical disk, can be coupled to the bus 905 to persistently store information and instructions (e.g., for the data repository 120).

The computing system 900 may be coupled via the bus 905 to a display 935, such as a liquid crystal display, or active matrix display. An input device 930, such as a keyboard or mouse may be coupled to the bus 905 for communicating information and commands to the processor 910. The input device 930 can include a touch screen display 935.

The processes, systems and methods described herein can be implemented by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein. One or more processors in a multi-processing arrangement may also be employed to execute the instructions contained in main memory 915. Hard-wired circuitry can be used in place of or in combination with software instructions together with the systems and methods described herein. Systems and methods described herein are not limited to any specific combination of hardware circuitry and software.

Although an example computing system has been described in FIG. 9, the subject matter including the operations described in this specification can be implemented in other types of digital electronic circuitry, or in computer software, firmware, or hardware, including the structures disclosed in this specification and their structural equivalents, or in combinations of one or more of them.

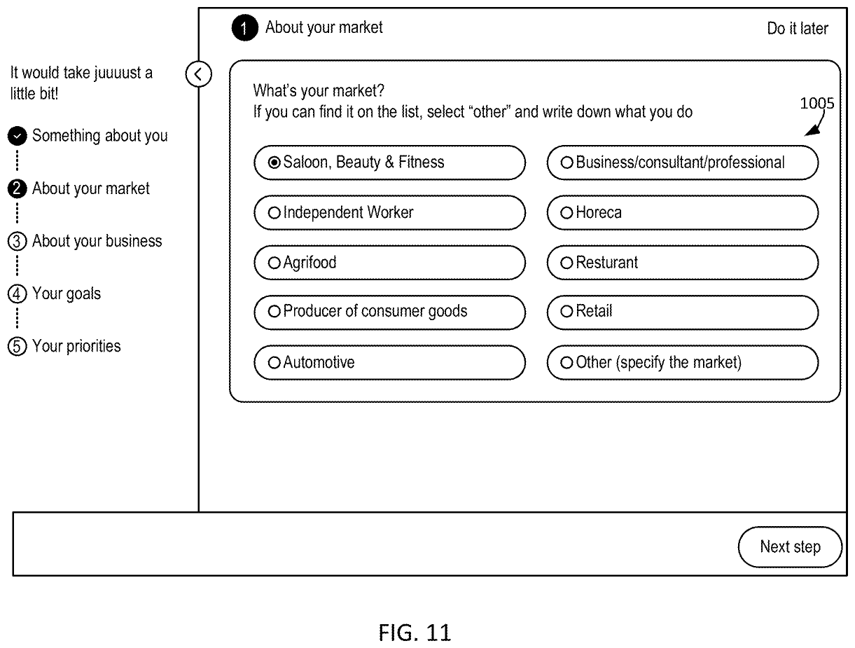

FIG. 10 depicts a display for a graphical user interface 108, in accordance with some aspects. For example, the display can include prompts 1005 for the entity (e.g., identification information for the entity), which along with other prompts 1005 disclosed herein, can be received by the user interface 108 for ingestion by the classification engine 102. FIG. 11 depicts a display for a graphical user interface 108, in accordance with some aspects. The display can include prompts 1005, such as prompts 1005 for a sector associated with an entity.

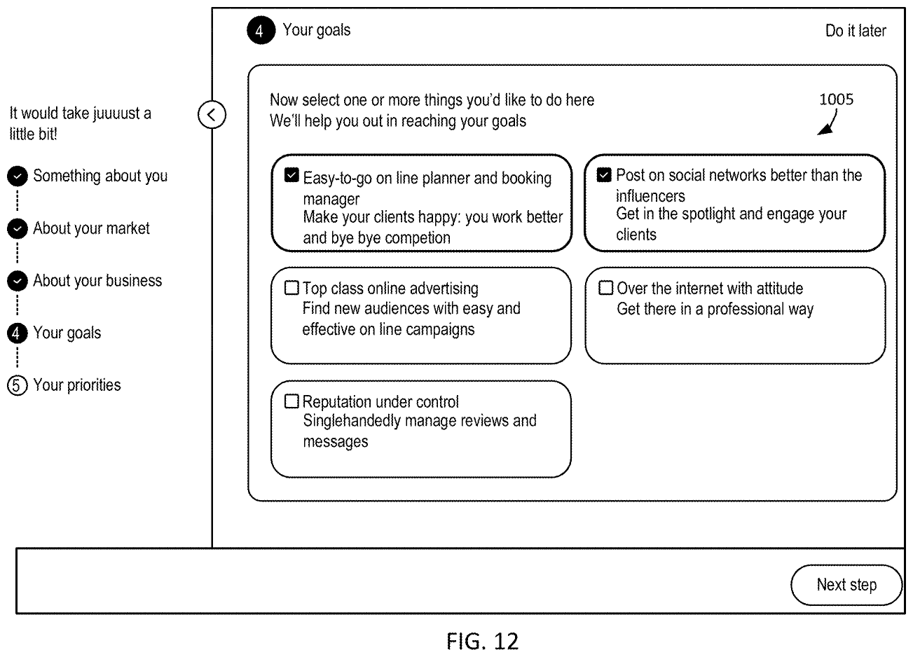

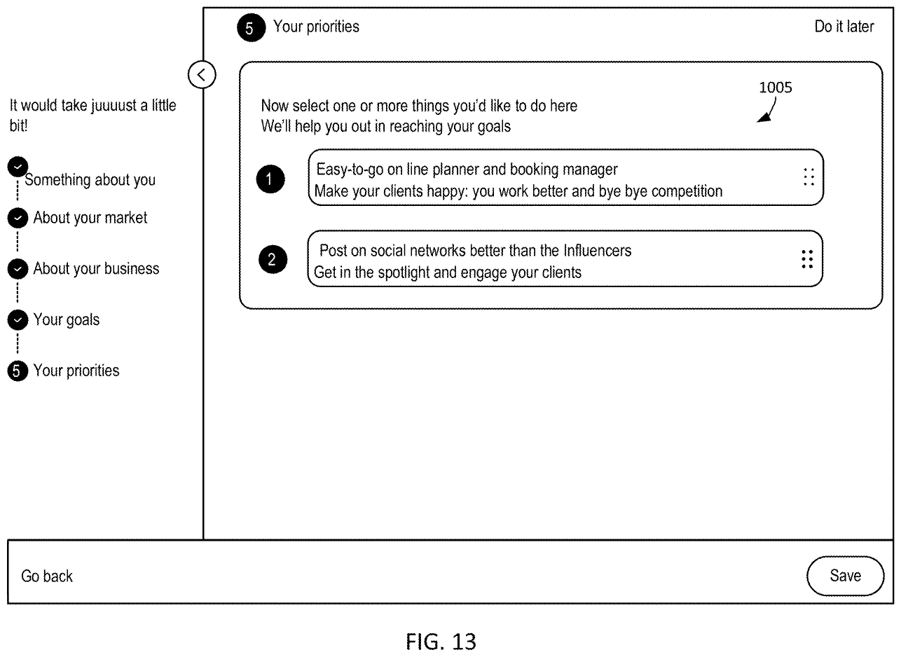

FIG. 12 depicts a display for a graphical user interface 108, in accordance with some aspects. For example, the display can include prompts 1005 for the entity, such as prompts 1005 for a desired outcome. FIG. 13 depicts a display for a graphical user interface 108, in accordance with some aspects. For example, the display can include prompts 1005 for the entity, such as prompts 1005 for weighting, ranking, or other prioritization of a desired outcome or display option.

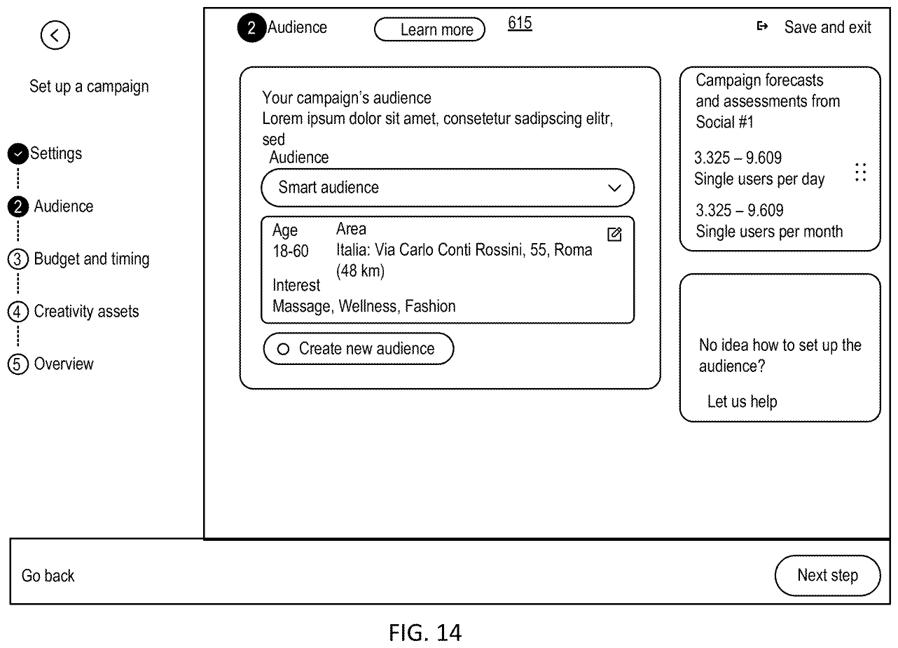

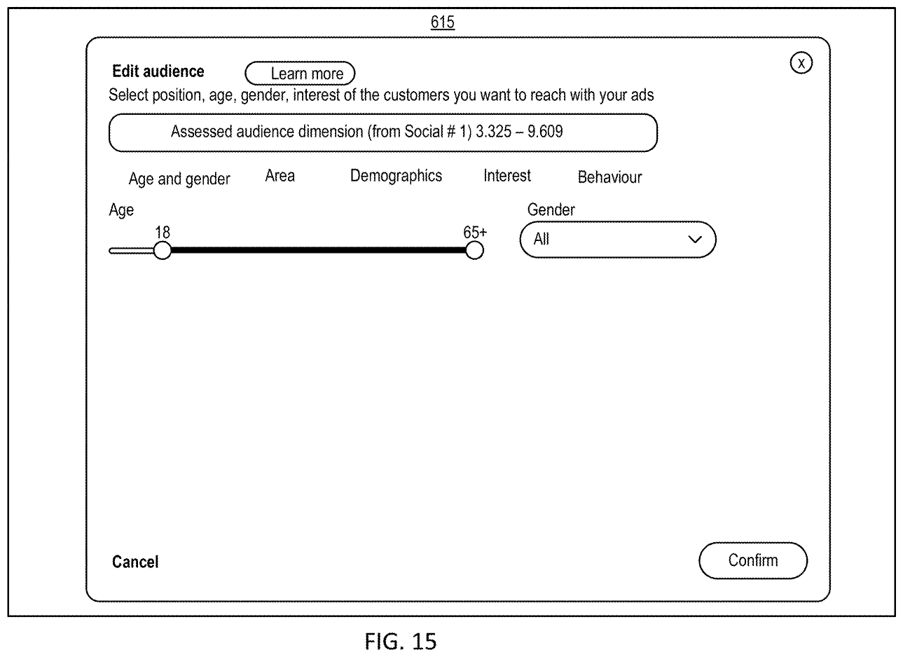

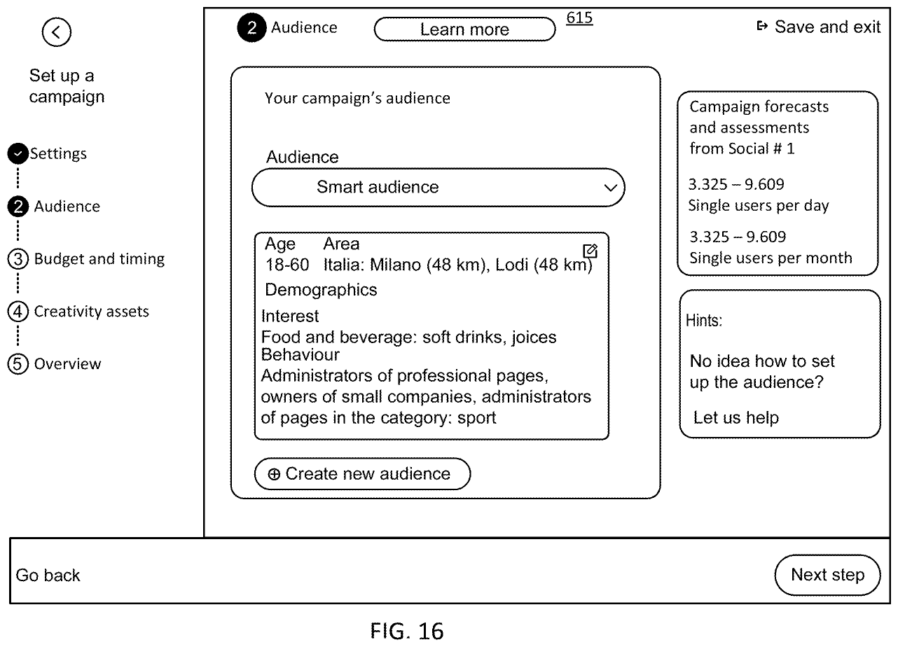

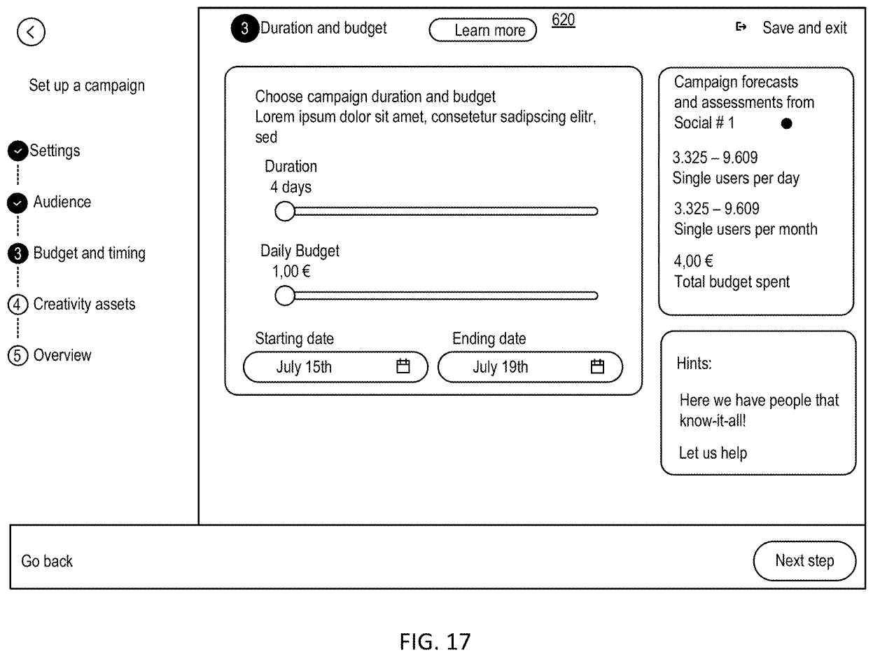

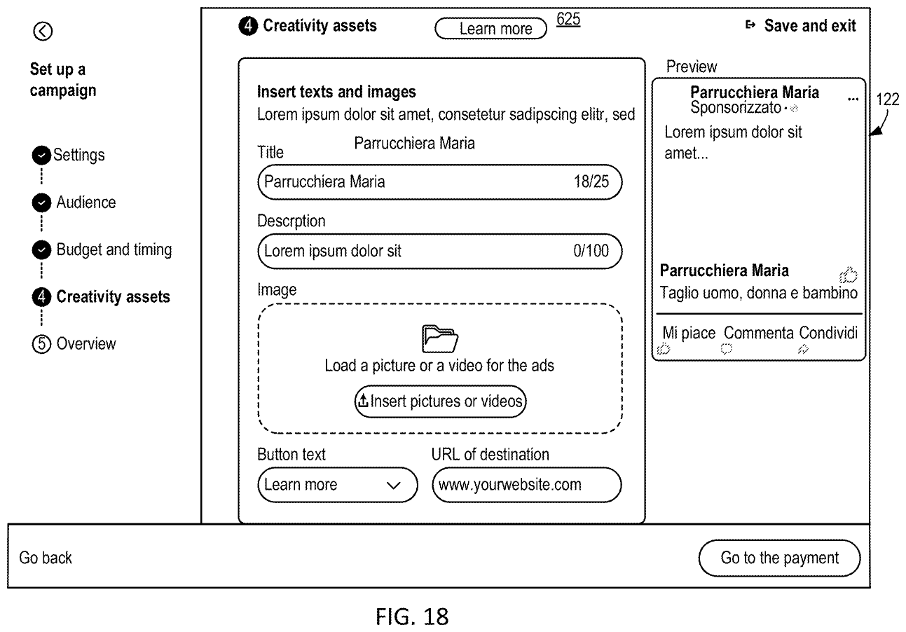

FIGS. 14, 15, and 16 depict displays for a graphical user interface 108, in accordance with some aspects. For example, the displays can include a second submenu 615 to define an audience for a distribution plan. FIG. 17 depicts a display for a graphical user interface 108, in accordance with some aspects. For example, the display can include a third submenu 620 to include a timing or magnitude of a distribution plan. FIG. 18 depicts a display for a graphical user interface 108, in accordance with some aspects. For example, the display can include a fourth submenu 625 to provide one or more suggested online content items 122 or prompt the user to provide an online content item 122.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. Computer-readable information can refer to electronically stored instructions or data (e.g., stored in a NAND or NOR flash, magnetic media, or other) or articles of manufacture. Some computer-readable information can be human readable. For example, computer-readable information can include punch cards or textual information which may be ingested by an optical character recognition (OCR) component of a computer, wherein the OCR component generates signals, instructions, or other data readable to other components of the computer.

In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code. Programming languages can further include natural language inputs, according to various NLP models. For example, the instructions or other information referred to herein can be received as natural language, wherein various translation, heuristic, or other models can generate processor instructions based on the natural language inputs. The NLP inputs or translated instructions associated therewith can be stored on a the non-transitory media.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit).

Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

What is claimed is:

1. A system, comprising:
a data processing system comprising one or more processors, coupled with memory, in communication over a network with a plurality of online content item providers, the data processing system to:
store a data structure for a plurality of unique endpoints;
establish a session with a first online content item provider;
access a data field from the first online content item provider via a first application programming interface (API);
establish a session with a second online content item provider;
access a data field from the second online content item provider via a second API, the data field from the first online content item provider corresponding to the data field from the second online content item provider;
correlate the data field from the first online content item provider and the data field from the second online content item provider with a unique identifier of a unique endpoint of the plurality of unique endpoints to generate aggregated endpoint information; and
recommend an online content item for distribution based on the aggregated endpoint information and a classification of an entity.

2. The system of claim 1, comprising the data processing system to:
generate a plurality of prompts for the entity;
cause the plurality of prompts to be conveyed to a user interface;
receive responses, via the user interface, corresponding to each of the plurality of prompts; and
classify the entity according to the responses.

3. The system of claim 2, wherein one or more of the plurality of prompts is generated in response to the receipt of one or more of the responses.

4. The system of claim 2, wherein, to determine a class of the entity, the data processing system is configured to:
receive, by a classification model of the data processing system, attributes for a plurality of other entities;
train, based on the attributes, the classification model to sort the other entities into a plurality of classes;
determine, from the responses, one or more attributes of the entity; and
determine, by the classification model, the class of the entity.

5. The system of claim 4, wherein the classification model is one of a decision tree model, a random forest model, an explainable boosting machine (EBM), a support vector machine (SVM), a neural network, or a Bayesian model.

6. The system of claim 4, wherein the classification model clusters the plurality of other entities, the clusters defined according to the attributes of the other entities, and the attributes of the entity

7. The system of claim 1, wherein the online content item is provided to a public location.

8. The system of claim 1, wherein the online content item is provided to a nonpublic location of one or more of the plurality of online content item providers for distribution to one or more unique endpoints, based on the aggregated endpoint information and the classification of the entity.

9. The system of claim 1, comprising the data processing system to:
receive, from the plurality of online content item providers, an indication of an impression to the online content item; and
recommend an additional online content item, responsive to the impression.

10. The system of claim 1, comprising the data processing system to:
provide endpoint information to an online content item provider of the plurality of online content item providers;
provide an indication to distribute the online content item to additional unique endpoints associated with the endpoint information;
receive information for an additional unique endpoint comprising an impression of the online content item; and
cause an additional online content item to be delivered to the additional unique endpoint based on the impression.

11. A method for generating content data item recommendations, comprising:
generating, by a data processing system, a plurality of prompts for an entity;
causing, by the data processing system, the plurality of prompts to be conveyed to a user interface;
receiving, by the user interface of the data processing system, first responses corresponding to each of the plurality of prompts;
classifying, by the data processing system, the entity according to the first responses;
storing, by the data processing system, endpoint information for a plurality of unique endpoints;
establishing a session, by the data processing system, with an online content item provider;
accessing, by the data processing system, a data field from the online content item provider via an application programming interface (API);
associating, by the data processing system, the data field with a unique identifier of a unique endpoint of the plurality of unique endpoints to generate aggregated endpoint information; and
recommending, via the user interface of the data processing system, an online content item for distribution based on the aggregated endpoint information and the classification of the entity.

12. The method of claim 11, wherein one or more of the plurality of prompts is generated in response to the receipt of one or more of the first responses.

13. The method of claim 11, comprising:
receiving, by the data processing system via the user interface, a query associated with a distribution of the online content item;
parsing, by a data processing system via natural language processing, the query to determine one or more topics associated therewith, the topics comprising search engine optimization (SEO), pay per click (PPC) content distribution, or social media site content distribution;
predicting, by the data processing system via a machine learning model trained on online content item distribution, an outcome for the distribution of the online content item associated with the topic, the prediction based on distribution information; and
generating, by the data processing system, a natural language response, responsive to the query, the natural language response including an indication of the prediction; and
presenting, by the data processing system via the user interface, the natural language prompt.

14. The method of claim 11, comprising determining a class of the entity by:
receiving, by a classification model, attributes for a plurality of other entities;
train, based on the attributes for the plurality of other entities, the classification model to sort the other entities into a plurality of classes;
determine, from the first responses, an attribute of the entity; and
determine, by the classification model, the class of the entity.

15. The method of claim 14, wherein the classification model is one of a decision tree model, a random forest model, an explainable boosting machine (EBM), a support vector machine (SVM), a neural network, or a Bayesian model.

16. The method of claim 11, wherein the online content item is provided to a nonpublic location of the online content item providers for distribution to one or more unique endpoints, based on the aggregated endpoint information and the classification of the entity.

17. A non-transitory computer-readable media comprising computer-readable instructions stored thereon that when executed by one or more processors of a data processing system cause the processors to perform a process comprising:
generating a plurality of prompts for an entity;
causing the plurality of prompts to be conveyed to a user interface;
receiving responses corresponding to each of the plurality of prompts;
classifying the entity according to the responses;
storing endpoint information for a plurality of unique endpoints;
establishing a session with an online content item provider;
accessing a data field from the online content item provider via an application programming interface (API);
associating the data field with a unique identifier of a unique endpoint of the plurality of unique endpoints to generate aggregated endpoint information; and
recommending an online content item for distribution based on the aggregated endpoint information and the classification of the entity.

18. The non-transitory computer-readable media of claim 17, wherein the computer-readable instructions further cause the one or more processors to determine a class of the entity by:
receive, by a classification model, attributes for a plurality of other entities;
train, based on the attributes, the classification model to sort the other entities into a plurality of classes;
determine, from the responses, one or more attributes of the entity; and
determine the class of the entity.

19. The non-transitory computer-readable media of claim 17, wherein the computer-readable instructions further cause the one or more processors to:
receive, from the online content item provider, an indication of an impression to the online content item; and
recommend an additional online content item, responsive to the impression.

20. The non-transitory computer-readable media of claim 17, wherein the online content item is provided to a nonpublic location of the online content item provider for distribution to one or more unique endpoints, based on the aggregated endpoint information and the classification of the entity.
